(19) United States
(12) Patent Application Publication
(10) Pub. No.: US 2015/0039694 A1
(43) Pub. Date: Feb. 5, 2015

(54) SYNCHRONIZED WEB-BROWSING

(71) Applicant: Been, Inc., New York, NY (US)

(72) Inventors: David H. Yoon, New York, NY (US); Sang Y. Shin, San Jose, CA (US)

(21) Appl. No.: 14/449,111

(22) Filed: Jul. 31, 2014

Related U.S. Application Data
(60) Provisional application No. 61/860,408, filed on Jul. 31, 2013.
(60) Provisional application No. 61/860,417, filed on Jul. 31, 2013.
(60) Provisional application No. 61/860,431, filed on Jul. 31, 2013.

(51) Int. Cl. H04L 29/08; H04L 12/18

(52) U.S. Cl. CPC H04L 67/26; H04L 12/1813
USPC 709/204

(57) ABSTRACT

A computer apparatus, and computer-based method for sharing of clickstreams and demographic information between users browsing the Internet, including a graphical user interface and database for clickstream data capture and storage that is combined across multiple users. Also described is synchronized web browsing in real time across multiple Internet browsing devices, and the use of WebSockets to communicate URL's/URI's loaded by a leader to all participants, thereby permitting the participants to the same URL/URI at the same time. The technology is implemented via a web browser extension, or as an app on a mobile device. Also described are ways for users to add free-form content, including but not limited to text, to individual URL's, and for managing access to such content by the individuals themselves or by other individuals whereby the content creator can select who can view the content when the URL/URI is viewed through an Internet browsing device.

### CLAIM OF PRIORITY

This application claims the benefit of priority under 35 U.S.C. §119(e) to U.S. provisional application serial nos. 61/860,408, filed Jul. 31, 2013, 61/860,417, filed Jul. 31, 2013, and 61/860,431, filed Jul. 31, 2013, all of which are incorporated herein by reference in their entirety.

### RELATED APPLICATIONS

The instant application is related to the following U.S. Provisional patent applications, all of which are incorporated herein by reference in their entireties:
Yoon, D., et al., application Ser. No. 61/860,391, filed Jul. 31, 2013, entitled “DATA EXCHANGE AND SERVICES PLATFORM”, attorney docket no. 1757-00-002P01;
Yoon, D., et al., application Ser. No. 61/860,453, filed Jul. 31, 2013, entitled “REPRESENTING CLICK-STREAMS”, attorney docket no. 1757-00-006P01; and
Yoon, D., et al., application Ser. No. 61/860,465, filed Jul. 31, 2013, entitled “GRAPHICAL INTERFACE FOR RECORDING AND DELAYED RECORDING OF URL'S/URI'S”, attorney docket no. 1757-00-007P01.

### TECHNICAL FIELD

The technology described herein generally relates to synchronized web browsing in real time across multiple Internet browsing devices, and more particularly relates to the use of WebSockets to communicate URL's/URI's loaded by a leader of a group to all the group's participants. The technology described herein further relates to sharing of clickstreams and demographic information between users browsing the Internet, and more particularly relates to a graphical user interface and database for clickstream data capture and storage that is combined across multiple users, with membership determined by the users. The technology described herein also relates to free-form content, including but not limited to, text that is tied to individual URL's/URI's, and more particularly relates to such content that is left by individuals for themselves or for other individuals where the content creator can select who can view the content when the URL/URI is viewed through an Internet browsing device.

### BACKGROUND

The clickstreams of Internet users arguably rank as some of the most valuable information available for understanding users' needs and preferences, both online and offline. They help identify and estimate the impact of the information the users receive and create, as well as how their opinions, tastes, and preferences form and change over time. Furthermore, due to the ease and speed with which users of the Internet can browse multiple web pages in any given amount of time, it has become more and more difficult for anyone to assess and take stock of the information encountered while browsing.

Nevertheless, there is a need for a platform that allows for both more useful data for the creation of personalized and targeted content, as well as greater control of the sharing of user clickstreams by the users themselves.

Though browsing the Internet is often conducted alone, there are times when viewing the same page at the same time together with others, who may or may not be co-located, is preferred. Such cases may include a classroom setting where a teacher may want to guide students through a series of web pages for a lesson. In other circumstances, a team of researchers using different devices may want to concurrently view and discuss a set of web pages. Alternatively, a group of people, such as friends or extended family members, may want to visit, from their respective homes, a merchant's web site together to browse through different product pages at the same time.

Though “screen-sharing” applications exist, where the same exact content is shown to all participants, this may not be ideal for a number of reasons. One core reason is that the shared pages may contain personalized private information (based on third-party cookies) that would be inappropriate to share amongst the group. A screen-share is a copy that is identical across view ports. Accordingly, there is a need for a platform that allows for greater control of the sharing of user clickstreams by the users themselves.

Other technology exists for sharing web-based content but some, e.g., U.S. Pat. No. 8,190,670, are directed towards sharing web-pages themselves, and not just the URL's for the web-pages. For reasons of data privacy, it is desirable for users not to share, e.g., cookies with one another. Additionally, such technology does not readily scale to user-groups numbering in the thousands.

Another technology, described in U.S. Pat. No. 8,010,901, describes how a server program (a servlet) is essentially acting as a “browsing proxy”, which broadcasts web pages to participants through the use of some web application or plug-in.

The technology described in U.S. Pat. No. 7,296,002 provides agent controlled synchronized browsing but at a custom terminal or kiosk.

Synchronized web scrolling is described in U.S. Pat. No. 6,958,981, which also involves transmission of web-page content.

Browsing the Internet, with its overabundance and ever-increasing amount of information, can be an organizationally and cognitively difficult activity. Much additional information could be provided, however, if users could readily share comments on URL's with one another in an organized fashion. The ability to associate individual and groups of web pages (the content located at a URL/URI) with free-form content, and have friends, co-workers, experts, and even strangers, associate web pages with content that provides context to the web pages as well as how the web pages relate to discussions outside of the Internet, as well as discussions about the information contained within the Internet, would provide help in making sense of the most useful parts of the Internet to the user. The ability to bundle the free-from content by subject and date, search through them, and associate them with voluntary groups of individuals, e.g., classmates, friends, family, colleagues, or interest groups, would be even more useful.

To be able to access such indexed and categorized content associated with individual and grouped web pages as users browse the web, wherever they may be on the Internet, would help users better track what they have learned, what they need to learn more about, and what they can do on the Internet as well as outside of the Internet.

U.S. Pat. No. 8,484,297 (“Method for collaboratively tagging and highlighting electronic documents”; issued Jul. 9, 2013) describes an algorithm for suggesting pages and people based on collections of annotations of web pages and text tags. It does not, however, describe ways of annotating pages or of sharing those annotations with select groups of users.

The discussion of the background herein is included to explain the context of the technology. This is not to be taken as an admission that any of the material referred to was published, known, or part of the common general knowledge as at the priority date of any of the claims found appended hereto.

Throughout the description and claims of the specification the word “comprise” and variations thereof, such as “comprising” and “comprises”, is not intended to exclude other additives, components, integers or steps.

### SUMMARY

The instant disclosure addresses the user access of websites in parallel, based on a linking of their clickstreams, in conjunction with a server. In particular, the disclosure comprises a computer program configured to permit one or more users to share and annotate their clickstreams, the computer program being executable as a browser extension on a desktop or laptop computer, or as an app on a mobile device, wherein the computer or mobile device is in communication via a network connection with a server.

The instant disclosure includes a computing apparatus for aggregating users' clickstreams into groups, the apparatus comprising: an Internet connection; a computer-readable memory, encoded with instructions; a processor executing the instructions; wherein the instructions provide for: recording the clickstreams of two or more users, wherein the clickstreams each comprise one or more URL's from the respective user's Internet session; associating one or more pieces of user-specific information with each of the two or more URL's in a user's clickstream; combining the clickstreams of the two or more users into a group of clickstreams; and storing the group of clickstreams in a database.

The instant disclosure further includes a method for aggregating users' clickstreams into groups, the method comprising: recording the clickstreams of two or more users, wherein the clickstreams each comprise one or more URL's from the respective user's Internet session; associating one or more pieces of user-specific information with each of the two or more URL's in a user's clickstream; combining the clickstreams of the two or more users into a group of clickstreams; and storing the group of clickstreams in a database; wherein the method is performed on a computing apparatus. The disclosure further includes a computer-readable medium encoded with instructions for implementing the foregoing method of aggregating users' clickstreams into groups.

The present disclosure further includes a computing apparatus for synchronizing web-pages viewed by a group of users, the apparatus comprising: an Internet connection; a computer-readable memory, encoded with instructions; a processor executing the instructions; wherein the instructions provide for: recording the clickstream of a session leader, wherein the clickstream comprises one or more URL's from the leader's Internet session; and pushing the URL's from the clickstream of the session leader to a plurality of participants, through a bi-directional transport layer over the internet; wherein the plurality of participants views the web-pages associated with the URL's at the same time as the session leader.

The present disclosure still further includes a method for synchronizing web-pages viewed by a group of users, the method comprising: recording the clickstream of a session leader, wherein the clickstream comprises one or more URL's from the leader's Internet session; and pushing the URL's from the clickstream of the session leader to a plurality of participants, through a bi-directional transport layer over the internet; wherein the plurality of participants views the web-pages associated with the URL's at the same time as the session leader; and wherein the method is performed on a computing apparatus. The disclosure further includes a computer-readable medium encoded with instructions for implementing the foregoing method of synchronizing web-pages.

The present disclosure still further includes a computing apparatus for sharing user comments on URL's, the apparatus comprising: an Internet connection; a computer-readable memory, encoded with instructions; a processor executing the instructions; wherein the instructions provide for: annotating a URL/URI with free-form content by a user; associating a set of permissions with the free-form content, wherein the permissions define whether one or more members of a group of users can view the free-form content; and providing the free-form content to the members of the group according to whether they have permission.

A method for sharing user comments on URL's, the method comprising: annotating a URL/URI with free-form content by a user; associating a set of permissions with the free-form content, wherein the permissions define whether one or more members of a group of users can view the free-form content; and providing the free-form content to the members of the group according to whether they have permission, wherein the method is performed on a computing apparatus. The present disclosure further includes a computer-readable medium encoded with instructions for implementing the foregoing method of sharing user comments on URL's.

### BRIEF DESCRIPTION OF THE DRAWINGS

FIG. 1 shows an exemplary browser extension for a web browser;

FIG. 2 shows an exemplary data structure for storing group properties with recorded URL/URI data;

FIG. 3 shows an exemplary graphical view of chronological clickstreams, as viewed from within a web browser.

FIG. 4 shows an exemplary graphical view of chronological clickstreams, as viewed from within a web browser.

FIG. 5 shows a tabular view of textual descriptions of combined clickstreams of a group of users.

FIG. 6 shows an exemplary browser web extension, seen by a participant;

FIG. 7 shows an exemplary browser web extension, seen by a Session Leader.

FIG. 8 shows another embodiment of a participant's browser extension.

FIG. 9 shows an exemplary interface for adding free-form content to a URL/URI.

FIG. 10 shows a schematic implementation of the technology herein on a client device.

FIG. 11 shows a schematic diagram of a computer configured to run the programs described herein.

FIG. 12 (comprising FIGS. 12A, 12B) shows a schematic diagram of a computer configured to run the clickstream monitoring programs described herein.

Like reference symbols in the various drawings indicate like elements.

### DETAILED DESCRIPTION

The instant technology is directed to aggregating and annotating clickstreams and selectively recorded URL/URI information from groups of individuals, and notifying members of the group when content has been updated.

The instant technology is further directed to a method for enabling multiple users of the Internet to view the same URL/URI at the same time using WebSockets technology via a web browser extension. The technology and method presented herein also allow for concurrent browsing of URL's/URI's across devices, thereby allowing for the sharing of core content across geographies at the same time, without the sharing of personalized data that may be private in nature.

The instant technology is still further directed to methods of tagging URL's with user-defined content and selectively sharing that content with other users. As users encounter content left by themselves or others, the associated web page (the content located at the URL/URI's) can be easily navigated to with the methods outlined herein.

It is to be understood that the technology herein is compatible with any web-browser software, including but not limited to: Internet Explorer, Safari, Chrome, FireFox, and Opera, and any version thereof.

### DEFINITIONS

Clickstream—an individual's Internet and Intranet browsing history, which is a collection of URL's/URI's that the individual accesses and views in sequence. The term “clickstream” may also be written as “click-stream” or “click stream” herein, without changing its meaning.

URL and URI—uniform resource locator and uniform resource identifier, respectively. It is assumed herein that a reference to any one of: URL/URI, URI, or a URL means either a URL or a URI or both.

Internet Browsing Device—a combination of hardware and software components that enables a user to view and update content on the Internet including, but not limited to desktop computers, and mobile devices such as laptops, notebooks, smart phones, and tablets.

API—an application programming interface that functions over the standard Internet and intranet communication protocols, which enables disparate web sites and web applications implemented in different technology stacks to exchange and process data securely with each other.

Browser extension—a computer program that extends the functionality of a web browser.

Referrer—the preceding URL/URI that a user was viewing before loading another URL/URI. There are many use cases that fall under this definition. The preceding URL/URI could be a web page from which the user clicked a link to navigate to another page. It can also be the prior tab or window the user was viewing before switching to another tab or window. It can also be the currently-loaded web page before a user types a new URL/URI in a browser's address bar and hits “enter” or “return”.

### Overview

The technology comprises a method for combining clickstreams and ancillary data (personal data, demographic information, contact information, including e-mails) of groups of people, where the groups are voluntarily formed by the members themselves. For example, a combination of URL/URI histories and ancillary data can be created within a family, within a classroom, among friends, among people with similar interests or among people with similar research objectives. There is no limit to how large the group can be, nor is there a limit to the number of different types of people who can choose to create a combination of URL/URI histories.

The technology is associated with a group of users (who do not necessarily know each other, or are not necessarily aware of each other's presence online). The users do have a common interest in accessing the same web-sites at the same time. The activity during which members of the group access the same web-site at the same time is referred to herein as a Session, or sometimes a “surfing together” session.

### Group Creation

The purpose of creating a group can also be provided by the group's members. Examples of applications include, but are not limited to, recording and viewing web pages visited and recorded by people with similar interests or common goals—e.g., interest in chess, hiking, photography, or URL's/URI's devoted to a particular vacation destination or product for purchase. The URL's/URI's in a group can be edited so that one or more of them can be deleted by the user who contributed the URL/URI to the group. Group members are typically not able to delete each other's URL/URI contributions.

The process by which a group is created for the purposes of combining users' clickstreams begins with a single user naming and starting a recording to a designated file (represented, for example, graphically by an icon and textually by a name). The group recording can also have a user-designated category by which members can index/reference it, e.g., research, travel, restaurants, or news. The first user then can invite additional users by sending a standardized e-mail or other means such as messages internal to the particular computer ecosystem. The users who are invited to the group can then choose to accept or reject the invitation. If they accept, they are automatically made members of the group, and their clickstreams are then included in the group history. Note that the creator of the group does not necessarily have to be a contributor. One can envisage, for example, a classroom teacher creating a group for the class and inviting all students in the class to join the group for a research project. The teacher can then monitor the progress of the project by reviewing the group's combined clickstream data.

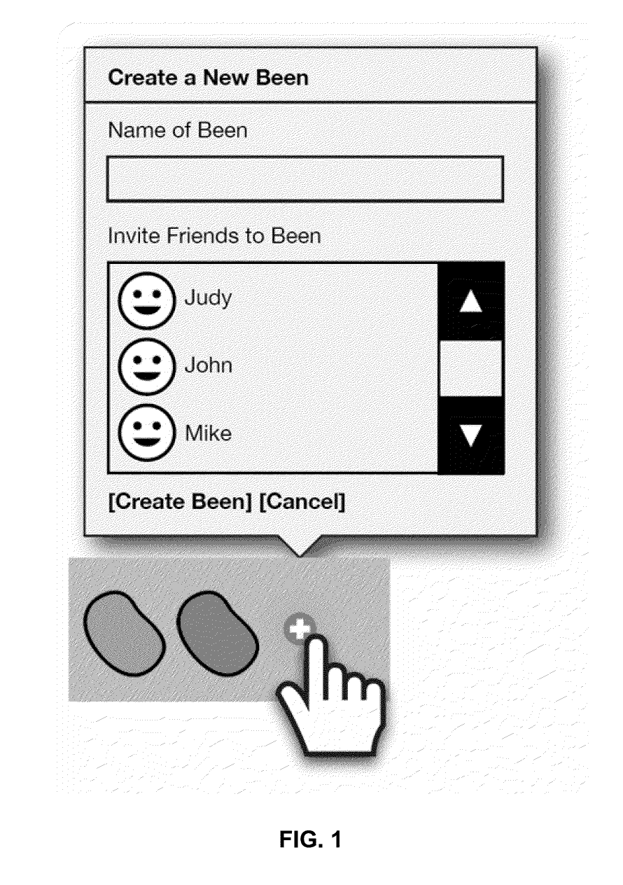

FIG. 1 shows how a group can be created through a browser extension that is installed in a web browser. In this embodiment, the group is depicted as a “Been”: a representation of the file to which clickstreams are recorded as described above. This is just one implementation of the functionality; there are many other ways to implement the same concept, for example using apps on a smart phone or any other platform. Ways to accomplish recording and other manipulations of clickstreams are described in copending application Ser. No. 14/449,073, filed Jul. 31, 2014, entitled “Clickstream Monitoring”, having first-named inventor Yoon, David, and attorney docket no. 1757-00-002U01, incorporated herein by reference.

### Surfing Together

A designated user (who can be referred to as the “Session Leader”) can browse either a pre-loaded sequence of URL's/URI's or provide an input to (e.g., click on) URL's/URI's manually to load them. Pre-loaded sequences of URL's/URI's can be manually created by users or generated by algorithms based on a variety of inputs including user clickstream and demographic data. It should be noted that the technology does not attempt to extract content or data from the web pages that the leader loads to send out to participants. It only sends to participants the URL's/URI's that the leader loads (or which can be pre-loaded), mainly because it is important to respect the users' privacy. This is also why cookies are also never transmitted to participants. The present technology is aimed towards online users, friends and followers, where privacy of personal data outside of URL's/URI's must be respected.

A pre-loaded sequence of URL's/URI's generated by algorithms can potentially be used as a targeted advertising promotion that the user views in order to obtain an incentive, one of which could be a discount for some product or service. In such a scenario, the Session Leader could be a program (not a person) that would lead users through the customized set of pre-loaded URL's/URI's before the users receive the incentive at the end of the session.

As the contents of the URL/URI load in the Session Leader's Internet browser, the same URL/URI is pushed to the other participants so that they will also load the same URL/URI in their browser through their browser extensions. The content that the participants load may differ from each other and from the Session Leader as only the URL's/URI's are pushed and not the content loaded from the URL/URI. In other words, personalized data for each user is not communicated during the “Surfing Together” sessions, and participants may have slightly different views of the same URL/URI depending on their personal cookies, accounts and other unique data. The group of participants can be chosen by the leader and participants themselves, who may elect to invite others to the “Surfing Together” session while the session is in progress.

Participants can also join a “Surfing Together” session by accessing a URL should the Leader enable the session to be broadcast to that URL. In a preferred embodiment, no special software is required for participants and they can use any device, including smart phones and tablets, with any browser to join the session, without having to log in using an account on the server. The Leader may choose to require a special code for participants to enter when accessing the URL, in order to limit public access to the session. In this case, only participants who know the code will be able to join.

WebSockets represents the preferred technology for implementing surfing together because it is full-duplex and bi-directional, which is critical when scaling up the number of participants. It is also geared towards a large number of participants for a marketing or PR event. An example use case would be a celebrity leading a large number of fans through a session.

The technology herein is fundamentally different from that described in the prior art for at least two reasons: First, browser extension and mobile app architecture enables the users to load the actual URL's/URI's being shared as if the user had manually loaded the URL/URI him/herself. The user sees the URL/URI in the address bar of his/her browser or mobile app. Private and personal data is preserved. Second, the use of WebSockets data transport protocol enables the system to scale to as many as thousands of concurrent users.

The technology further includes a method for linking free-form content created by one or more of a voluntary community of users and members with one or more URL's/URI's. The content is addressed to other members of the community, including the author of the content, and viewable, at the choice of the author, by him- or herself, by designated individuals, by the population of the group in its entirety, and/or by an author-selected subset of the population of the group. Both the input and the viewing of the content are seamlessly integrated with a user's Internet browsing experience such that no separate and/or distinct applications outside of the one (such as a web-browser) being used to view the web pages on the Internet are necessary.

One method of implementing the described functionality on a desktop or laptop computer is to use Internet/intranet browser extensions; it can be implemented in many other ways, including an app for a mobile device. A browser extension can annex the additional custom capabilities into a module within the browser itself, enabling the seamless integration within the browsing application between the author and the addresses. Other ways of sharing web-based information, such as that described in U.S. Pat. No. 8,484,297, do not rely on browser extension technology.

### Storage of URL/URI Histories

The recorded URL/URI histories reside in a persistent storage medium such as a database. An important requirement when storing the data is that each URL/URI, along with all of its recorded properties including, but not limited to, time of access, duration of access, and referring URL/URI, can be tagged as being part of one or more of the groups so that the data can be aggregated and structured for display and management in a flexible and expedient manner.

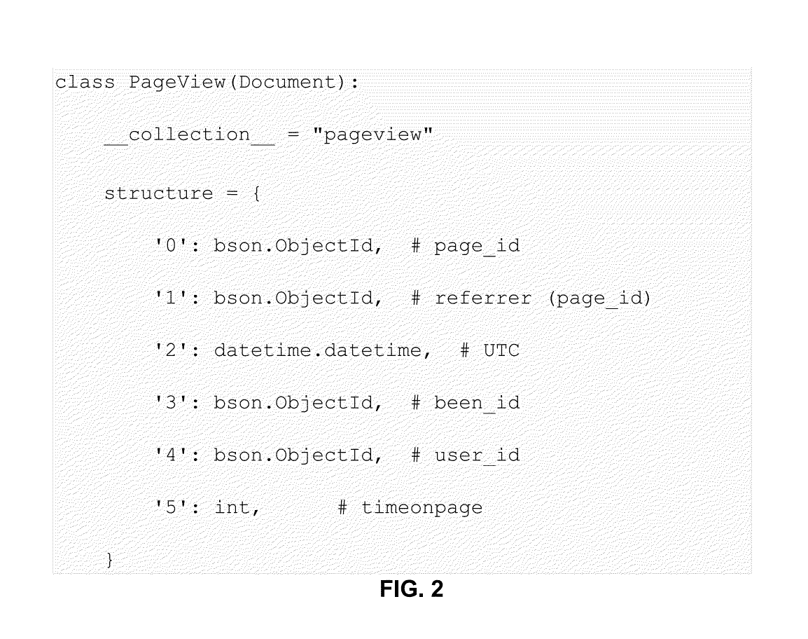

One example of how to implement this would be to use a NoSQL database like MongoDB, in conjunction with python via PyMongo, to create the data structure shown in FIG. 2 to store each URL/URI (referred to as PageView in the example). Note how BSON is used to maximize performance (BSON is a binary-encoded serialization of JSON-like documents).

### Calculating and Viewing Histories

At any time, a user who is a member of the group, or a third party with permission from a member of the group, may view the recording in multiple formats: either chronologically or most-visited within a certain user-chosen time interval by the entire membership in the group, e.g., last hour, last 24-hour period, last month, last year, or within a specified time period (e.g., between 2 am GMT Jan. 2, 2011 and 7 pm GMT Feb. 15, 2012).

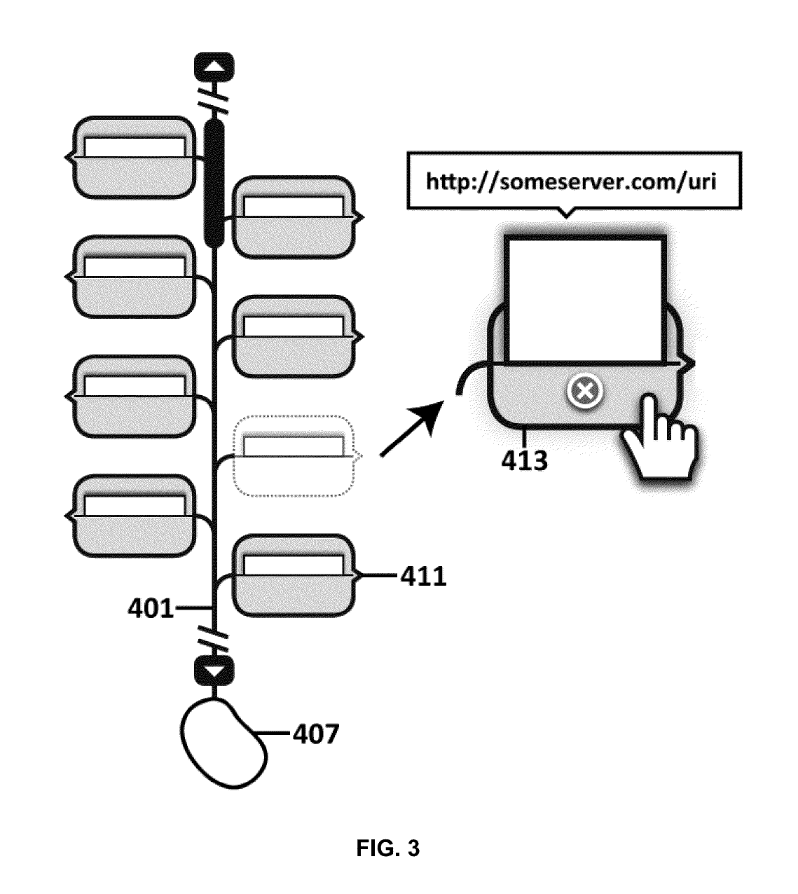

The chronological and most-visited within a time period results can be viewed in tabular/textual format and in graphical form. In graphical form, the chronological view can be a linear view of icons representing the URL's, i.e., thumbnails or images of the actual URL's/URI's. FIG. 3 shows an example of how the chronological graphical view of combined clickstreams of a group could look like when launched from a browser extension within a browser.

The pages, such as 411, broadly resemble leaves, on a stalk 401, within which the thumbnails of the contents of the URLs are partially or fully overlaid. A method for viewing more than a limited number of URL-indexed pages in thumbnail form allows for scrolling to display additional thumbnails, organized chronologically. Clicking on any leaf will take the viewer to the URL/URI associated with the depicted web-page typically by launching a web-browser or by opening the page within an already-running browser. As shown, a leaf associated with a particular web-page 413 may be selected and deleted from the view.

The graphical form of the most-visited within a time period list can use different sizes of the thumbnails or images to reflect the ranking of the URL's/URI's, from the most visited URL/URI to the least visited, respectively for each time period.

For any given time period, the server application will scan URL's/URI's that fall within the specified timeframe and that have the group ID tagged to them. The server application will then determine, within that collection, the URL's/URI's that have been viewed the most (by count) by the members of the group.

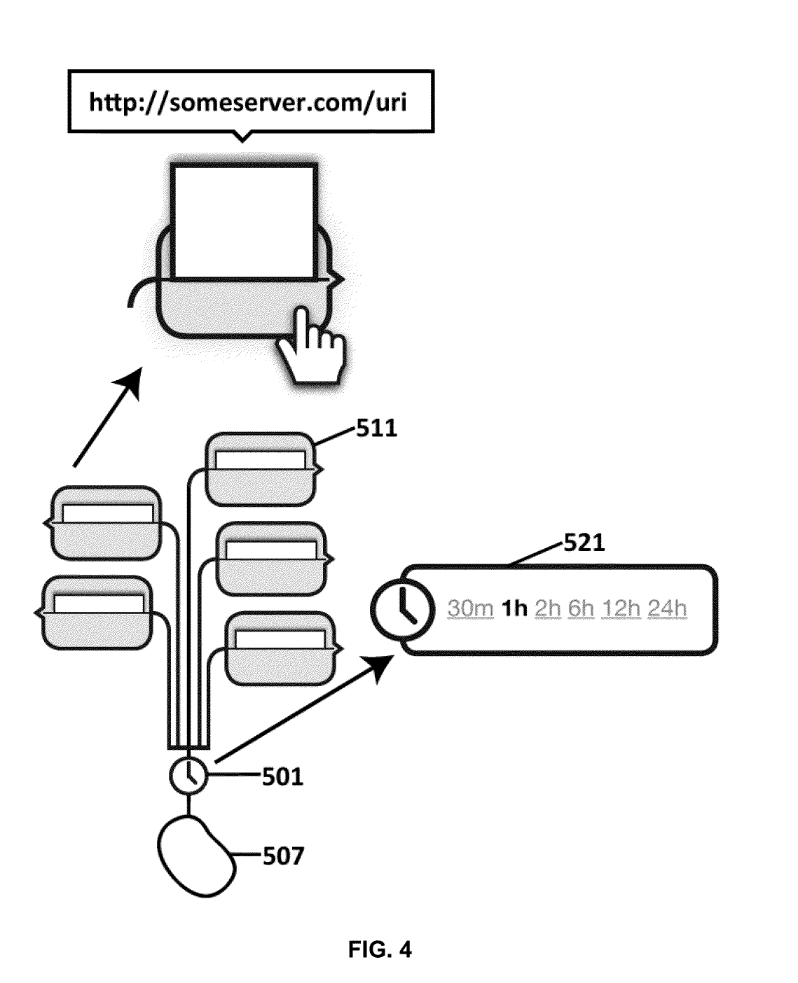

FIG. 4 shows how the most-visited graphical view of combined clickstreams of a group could look like when launched from a browser extension within a browser. It is showing the five most visited web pages within the past hour for the group.

A set of leaves (five in the example shown in FIG. 4) represents the most visited URLs in a specified time period by an individual recording their Internet browsing history to the particular file. Each leaf 511 has a URL/URI and a thumbnail webpage associated with it. Button 501 for example, enables a user to determine the time period. Clicking on button 501 reveals a menu 521 of time periods permitting a user to select the desired one.

The relative and/or absolute area of the leaves can be determined by the relative popularity (or frequency) of the URLs and associated thumbnails in the database within a specified time period.

Additionally another attribute of the way the leaves are displayed, for example the color of the leaves, is determined by how long, on average, users stay on a particular page. Other attributes of the leaves can represent aspects such as whether users have linked text specific to that page, and the degree to which users like or dislike a page.

Clicking on a leaf will load, in a web browser, the URL/URI associated with the thumbnail on the leaf, as shown in FIG. 4 for the leaf associated with the URL someserver.com/uri.

There can also be an icon on the leaf to show a set of additional leaves, representing the most frequent destinations navigated to from the URL/URI represented by that leaf, of users recording to this file.

The following data items can be recorded from member users who opt-in to join and become active members in the group.

The browsing histories can be linked to the personal and demographic information (e.g., name, age, gender, location) and contact information of the user (e.g., e-mail address, mailing address, phone), as provided by the user or as gleaned by the system from other sources on the user's Internet browsing device.

URL's/URI's are recorded when loaded in an Internet browsing device. A URL/URI is recorded if any one of the following conditions is met:
a. The loaded URL/URI stays loaded for at least a pre-set interval of time;
b. The user navigates away from the loaded URL/URI within a pre-set interval of time; and
c. The Internet browsing device's tab/window that displays the loaded URL/URI is moved to the background by bringing another window/tab to the foreground within a pre-set interval of time.

The pre-set interval of time applicable to a-c can be chosen by the user, such as selected from a list of pre-defined times (for example 0.5, 1, 2, 3, 5, 10 s), or can be set to a value chosen by the user. The application initially assigns the pre-set interval of time a default value, such as 5 s.

Time data can be recorded for each URL/URI and can comprise the time stamp (e.g., in Coordinated Universal Time (UTC)) of when URL/URI is recorded, and, optionally, the length of time spent on a URL/URI before navigating away or bringing another tab or window to the foreground or into focus.

Other web page properties that can be recorded include one or more of: Web page title (e.g., from value in the <Title> HTML tag if available); Referrer (e.g., the HTTP referrer as defined by the W3C (i.e., current web page accessed by clicking on a hyperlink from the previous web page); the Web page that was previously loaded before manually typing in a new web page address; and the Web page of the previous tab if another tab is brought to the foreground); thumbnails of web pages, generated by a separate thumbnail server accessing saved URLs so that no personalized/private content is in the thumbnails; favicons (a set of icons associated with a particular Web Site or Web Page) of URLs (domains) visited; Viewport scrolling coordinates when “Surfing Together” (an activity during which members of the group access the same web-site at the same time); Flag for marking a web page as a favorite; Notes dropped on web pages (free form content created and saved for oneself or for others associated with a URL/URI); Browser type and version used to view the web page; and Operating system type and version used to view the web page. It is to be understood that this list is not exhaustive or exclusive and that other properties of web-pages can be recorded in addition to or in place any one of the foregoing properties.

From the most visited list view, viewers (either users or third parties who have permission to view the data) can choose to see, either in tabular/textual view or graphical view, what URL's/URI's, as a group, the members visit from any of the URL's/URI's on the list. In other words, for each URL/URI, there can be, depending on the available data, a set of URL's/URI's that users navigated to from the source URL/URI. This set of URL's/URI's can be ranked and displayed in terms of the number of times they were accessed by the group members. These “subsequent” URL's/URI's are thus listed in terms of rankings from most often/popular to least often/popular. Aggregating the referrer URL/URI data is what makes this functionality possible.

The lists of URL's/URI's created thereby can also be searched for key words in the titles, the text of the URL/URIs, as well of the text of the contents of the HTML.

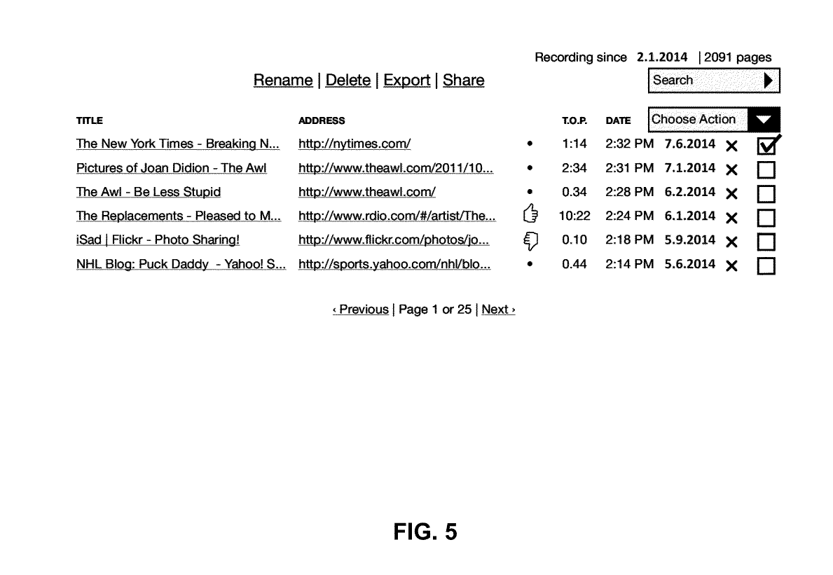

FIG. 5 shows example of a tabular/textual view of the combined clickstreams of a group. Each of the columns can be sorted, and the data can be exported to a portable file format. Although not shown, URL's/URI's can be deleted by marking them and then selecting “delete” from the “Choose Action” drop down.

### Session Start

The Session Leader and participants are not required to create accounts or login to a platform in order for “Surfing Together” to work (although they could if the “Surfing Together” function is part of a platform or integrated with a platform that includes one or more social networks). All that is required is that the Session Leader(s) have the web extension or mobile app installed. Users can participate anonymously if they wish to, and they are not required to have the web extension installed.

Invites can be sent either by the Session Leader who starts the “Surfing Together” session or by participants who invite others while the session is in progress. The invitations can be sent by e-mail or other electronic means, including messages on a platform if applicable. The invitations must be accepted, (for example, either by clicking on a link or a button), by users who wish to participate in order for them to join the session. Accepting the invitations will require loading a specific URI which will instantiate the session for the invitee through the web extension or any browser should the invitee not have a web extension installed.

An example of an invite screen might be a simple notification to the user, indicating the name of the inviter, and offering the user an optional field to input their own name. Clicking on a link (such as a button, or a textual link, e.g., “Let's go”) in the invite loads the URI, which instantiates the session for the invitee.

Invitations are one way of adding users to a “Surfing Together” session, but it is not the only way for a user to join such a session. A scheduled “Surfing Together” session could be created, where users click on a link to a URI to join without being explicitly invited. For example, this URI and scheduled “Surfing Together” session could be posted on a website, blog or made available via an app, as a marketing or publicity event.

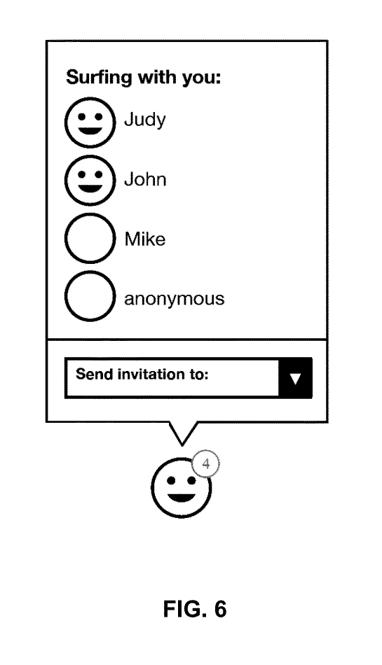

In the example in FIG. 6, the browser web extension (which is not required but is referred to herein as an example implementation) shows the participants of an active “Surfing Together” session by name with a drop-down to select additional users in a platform to invite. This drop down could be a field where users can type in e-mail addresses of others to invite. Note how one of the participants is anonymous, a feature that can be optionally available to any user.

### Browser Extension and Mobile App

All participants, including the Session Leader must install the browser extension or mobile app that enables the “Surfing Together” functionality. The browser extension or mobile app provides the Session Leader with a way to broadcast URL's/URI's being accessed. Participants can receive the URL's/URI's and load them locally through their browser, mobile app, or browser extension if installed. If participants have the browser extension or mobile app installed, they can be made Session Leaders and passed controls of the “Surfing Together” session.

Although not required, the use of browser extensions and mobile apps by participants provides the best user experience. All web pages can be received without difficulty since dynamic web extension code is injected in real time into the downloaded stream of HTML and CSS data from the server as the browser or mobile app renders pages. This enables the true preservation of a user's browsing experience while adding all the functionalities required for “Surfing Together.”

Additionally, the browser extension and mobile app can provide ancillary functionalities to support the main concurrent/mirrored browsing functionality. One function would be a way to facilitate concurrent scrolling, where scrolling behavior on a web page by the Session Leader is replicated to all participants. The coordinates of the content relative to the browser's viewport can be calculated by the browser extension or mobile app using inputs from the browser's built-in scrolling event handler and Document Object Model (DOM). The coordinates can then be broadcasted to participants using the same data transport exchange that URL's/URI's are communicated through (WebSockets). Once received, the client browser extension or mobile app uses the data to reposition the content within the client's browser viewport so that the same portion of the web page's content is displayed.

Other examples of ancillary functions include real-time messaging between members of the session, voice/sound chatting, display of the status of invited members (whether they are online, offline, whether they stopped the browsing), and recording of URL's/URI's accessed during the session for perusal at a later time.

### Session Behavior

As the Session Leader navigates from one URL/URI to another in a sequence (through a pre-loaded list, via a hyperlink, or by manual input of the next URL), the other participants in the session can choose to allow their browsers to move to the next URL/URI concurrently with the Session Leader's navigation, or to pause. Pausing allows participants to remain on the initial page or to navigate to pages related and unrelated to the Session Leader's navigation. Session participants can always return to the concurrent navigation and load the URL/URI for the page on which the Session Leader is active.

Session Leadership can only be bestowed on one participant at a time. However, a Session Leader can be transferred from one participant to another at any time. A new Session Leader will have the ability to navigate through his/her own pre-loaded list of URL's/URI's, navigate using links, or navigate to new URL's/URI's manually inputted into the browser.

At any time, participants can exit the session and re-enter, using the browser extension.

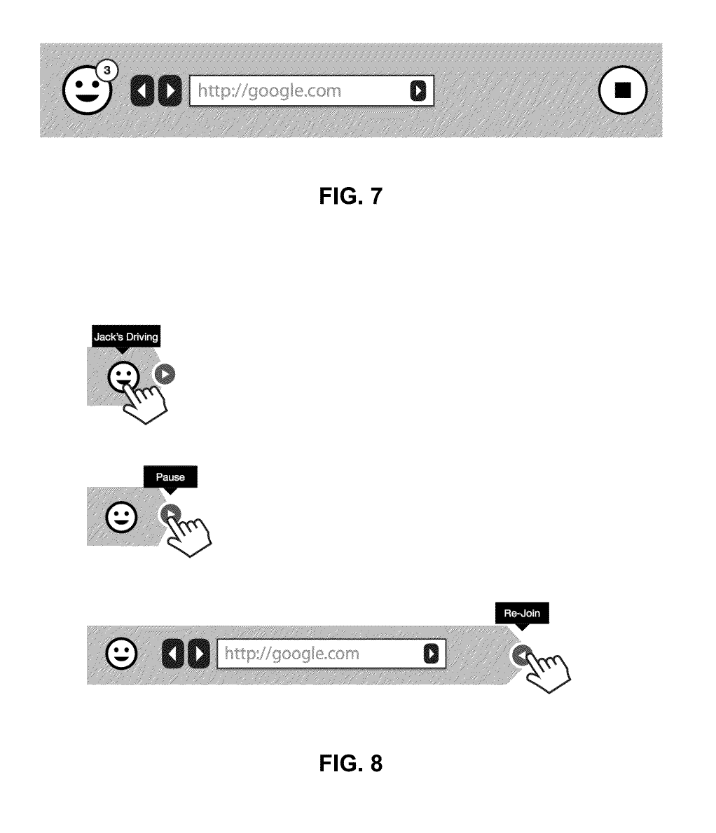

The example in FIG. 7 shows one embodiment of the Session Leader's browser extension; it resembles a bar. This bar could be displayed at, for example, the bottom of the browser's viewport. It allows the Session Leader to see the number of participants, as shown by the number over the face icon. This number can increment as users join and leave the session. The stop button on the far right can be used to end the session, and the left and right arrows would allow the Session Leader to cycle through a pre-loaded set of URL's/URI's which would be displayed in the address field. The Session Leader can also type in URL's/URI's to load new web pages or click on links on currently loaded web pages.

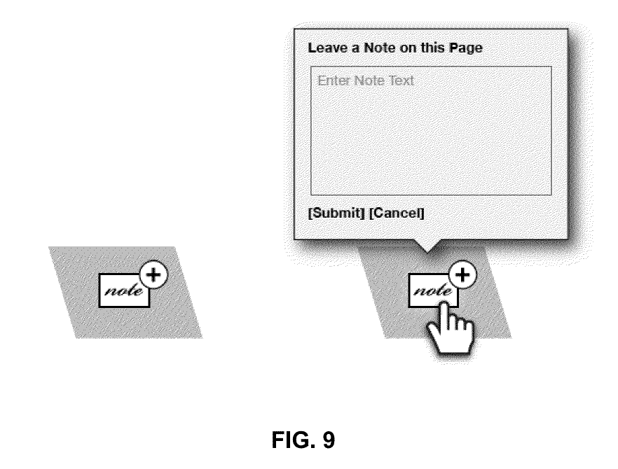

The example in FIG. 8 shows an embodiment of a participant's browser extension. Two different states are shown. The first state is when Jack, the Session Leader, is driving, and the participant is loading the same URL's/URI's that the Session Leader is loading. If the participant clicks on the Pause button, a second state of the web extension is triggered where it expands and enables the participant to surf around while the “Surfing Together” session continues. The participant can cycle through URL's/URI's loaded while paused by clicking on the left and right arrows. This enables the participant to experience the session at his or her own pace. Clicking on the Re-Join button collapses the web extension and loads the current URL/URI that the “Surfing Together” session is on and re-syncs the participant with the Session Leader so that the session carries on in real-time.

Although not shown in the figures, ancillary functionality can be added to the web extension and mobile app to provide a richer experience for the users. Such additional functionality could be represented as, for example, additional icons and buttons on the browser extension.

### WebSockets Data Transport Protocol

In order to achieve concurrent/mirrored web browsing in real time across multiple browsers with minimum diminution of performance, WebSockets can be used as a transport mechanism. The use of WebSockets enables an efficient communication channel between the Session Leader and participants through an intermediary socket server, which can be scaled up to include a farm of socket servers.

WebSockets is the technology of choice for implementing “Surfing Together” functionality because it is the only bi-directional transport mechanism functioning over HTTP currently implemented by the major web-browsers (FireFox, Chrome, Internet Explorer, Opera, and Safari) and mobile operating systems including, but not limited to iOS and Android. The WebSocket API is also in the process of becoming a standard and is under review by the W3C.

Due to the bi-directional and true, full-duplex, nature of the protocol, WebSockets enables socket servers to push URL's/URI's received from the Session Leader to all participants in-real time without the participants having to solicit data from the server through some form of continuous polling. Continuous polling by clients would greatly increase load and traffic to the server. Using WebSockets, a single HTTP connect tunnel can be established between the socket server and a participant of the “Pod Surfing” session through which data exchanges can take place efficiently using the bi-directional nature of WebSockets. Ancillary functionality, such as real-time chatting and audio communication methods mentioned earlier can also be transported through WebSockets via the socket server between the Session Leader and other participants, all in real-time.

The WebSocket API is still evolving (it is still in the process of being standardized by the W3C), and as a result, implementing the technology for different browsers can be complex due to nuances in each browser's current interpretation of the transport mechanism. Until the API is standardized, these nuances will continue to pose coding efficiency problems. As such, using an open source web socket library, such as Socket.IO is an alternative way of implementing the technology. In such a scenario, the Socket.IO library is installed on both the server and in the client browsers. The client browsers will have the Socket.IO library installed as part of the browser extension package, and doing so ensures that the code built on top of the Socket.IO library will function properly across the different browsers, even with browser updates being pushed to users that have changes to WebSocket behavior that developers can't control. Clients built using a mobile app can implement open source wrappers such as SocketRocket for iOS.

An example medium scale implementation could require separate session and socket servers in a farm configuration. To create a new “Surfing Together” session, the Session Leader creates a new session on the session Server. The session server is aware of all of the socket servers in a farm and their load status through a heartbeat with metrics on server utilization. Once a session is created, an available socket server in the farm is returned to the Session Leader based on server load availability, and all participants (including new participants) connect to this socket server as the intermediary socket server to facilitate the bi-directional data exchange.

### Inputting Text and Linking Text to URLs/URIs

Multiple groups of free-form content by the same user or by different users can be linked to a unique URL/URI. The form can include, but is not limited to: comments on the contents loaded onto the Internet browser by the URL/URI or messages addressed to a user-selected set of recipients. This allows users of the Internet browser extension to link free-form content to the URL/URI without regard to how many other comments have been inputted by a single user or how many comments have been left by other users.

Free-form content linked to URL's/URI's can also be tagged with appropriate key words to help sort and organize URL's/URI's linked to them.

### Viewing Text Linked to URLs/URIs

Either the author of the inputted free-form content linked to a URL/URI or recipients, designated by the author, of the text can view the inputted free-form content when they navigate to the URL/URI. One way, among others, to initiate the display of the free-form content in the Internet browser extension is to notify the user of free-form content linked to that URL/URI with a designated icon when the user navigates to that URL/URI. In response to the notification, the recipient (or the author) can choose to view the free-form content appropriate to that URL/URI and its contents.

The viewer of the URL/URI can be shown an identifying name (e.g., user-name, e-mail address, or nickname) of the author of the free-form content, linked to the URL/URI.

### Graphical and Textual Interface

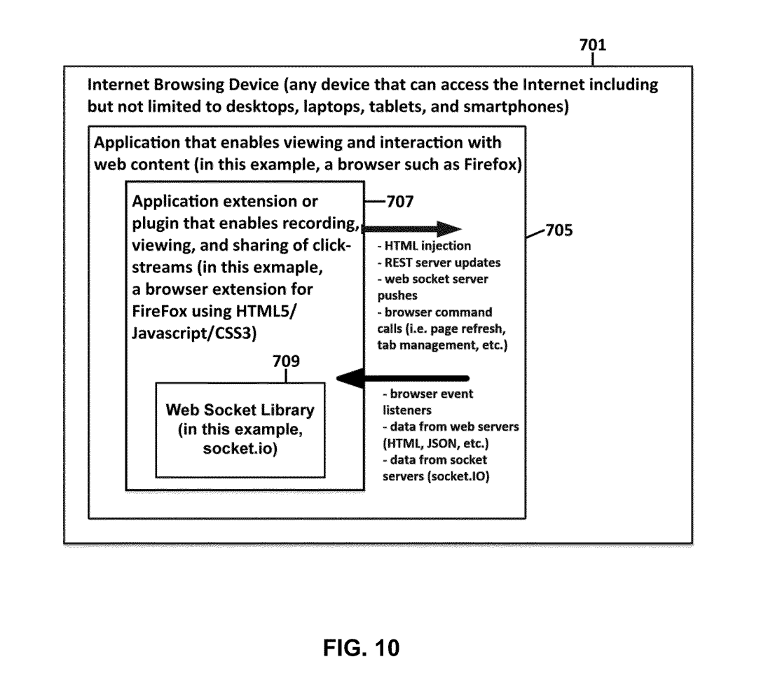

The Internet browser extension or mobile app through which free-form content linked to a URL/URI is both inputted and read can be unobtrusive enough to allow the user to see most of the content loaded onto the Internet browser by that URL/URI. A visual representation of one embodiment of the interface is shown in FIG. 9.

Navigating URL's/URI's Indexed by Text Linked to URLs

The organized, itemized, and tagged list of free-form content linked to URLs/URIs can be searched and ordered, thereby providing a way to navigate to URLs/URIs based on the free-form content inputted by the user on the content loaded into the browser by the URL's/URI's.

### Database and Communication Between Internet Browser Extension, Mobile App, and Database

The database for the storage of the free-form content and the linked URL/URI holds one or more pieces of the following data, preferably at least item a, and one of items c, or d:
a. URL's/URI's visited by one or more users;
b. Time stamp, duration, and referring URL/URI for each of the visited URLs;
c. User inputted text linked to the visited URL/URI (free-form content);
d. User inputted images or other binary data linked to the visited URL/URI (free-form content);
e. Identification code (e.g., name or e-mail address) of the author of the inputted text;
f. Identification code of the users (including the author) given permission by the author to view the free-form content linked to the URL; and
g. Flag designating whether the rest of the community can view the free-form content or not.

The database can be SQL or NoSQL in structure, although having a NoSQL structure may be more efficient for data transport using common Internet data objects such as JSON or JSONP. In such an implementation, a NoSQL database such as MongoDB can be exposed via an API architecture, for example, using Python such as PyMongo. The API can then be connected to web services running on web servers which would transmit JSON data with clients that have the browser extensions installed.

### Exemplary Implementations

The technology can be implemented to run within a web-browser, for example on a desktop personal computer or a laptop or notebook or tablet computer. The technology can also be implemented to run as an “app” (or application program) that runs on a mobile device such as a mobile or cellular phone, a personal digital assistant, or a tablet such as an iPad. When implemented to run within a browser, the technology is typically developed as a “browser extension” because it can be developed using existing browser capability, rather than as a plug-in. Different existing web-browsers refer to extensions differently: for example, FireFox refers to such an object as an “add-on” where Safari, Internet Explorer, and Chrome refer to them as “extensions”. However, plug-in based implementations for any of the browsers are not precluded. When implemented to run as an app, the app also provides basic browser functionality.

It is further contemplated that the technology run in a client-server implementation, whereby the user logs in or otherwise connects to a server that provides the functionality for clickstream monitoring.

The computer functions for managing a user's clickstreams, as described herein, can be developed by a programmer skilled in the art. The functions can be implemented in a number and variety of programming languages, including, in some cases mixed implementations. For example, the functions as well as scripting functions can be programmed in C, C++, Java, Python, HTML5, CSS3, Perl, .Net languages such as C#, and other equivalent languages. The capability of the technology is not limited by or dependent on the underlying programming language used for implementation or control of access to the basic functions. Alternatively, the functionality could be implemented from higher level functions such as tool-kits that rely on previously developed functions for manipulating URL's.

The technology herein can be developed to run with any of the well-known computer operating systems in use today, as well as others, not listed herein. Those operating systems include, but are not limited to: Windows (including variants such as Windows XP, Windows95, Windows2000, Windows Vista, Windows 7, and Windows 8, available from Microsoft Corporation); Apple iOS (including variants such as iOS3, iOS4, and iOS5, iOS6, iOS7, and intervening updates to the same); Apple Mac operating systems such as OS9, OS 10.x (including variants known as “Leopard”, “Snow Leopard”, “Mountain Lion”, “Lion”, and “Mavericks”; the UNIX operating system (e.g., Berkeley Standard version); and the Linux operating system (e.g., available from Red Hat Computing).

To the extent that a given implementation relies on other software components, already implemented, such as functions for accessing or manipulating web-pages, those functions can be assumed to be accessible to a programmer of skill in the art.

Furthermore, it is to be understood that the executable instructions that cause a suitably-programmed computer to execute methods for managing a user's clickstreams, as described herein, can be stored and delivered in any suitable computer-readable format. This can include, but is not limited to, a portable readable drive, such as a large capacity “hard-drive”, or a “pen-drive”, such as connects to a computer's USB port, and an internal drive to a computer, and a CD-Rom or an optical disk. It is further to be understood that while the executable instructions can be stored on a portable computer-readable medium and delivered in such tangible form to a purchaser or user, the executable instructions can be downloaded from a remote location to the user's computer, such as via an Internet connection which itself may rely in part on a wireless technology such as WiFi. Such an aspect of the technology does not imply that the executable instructions take the form of a signal or other non-tangible embodiment. The executable instructions may also be executed as part of a “virtual machine” implementation.

The technology described herein can be implemented in many different ways, of which one exemplary way is as follows.

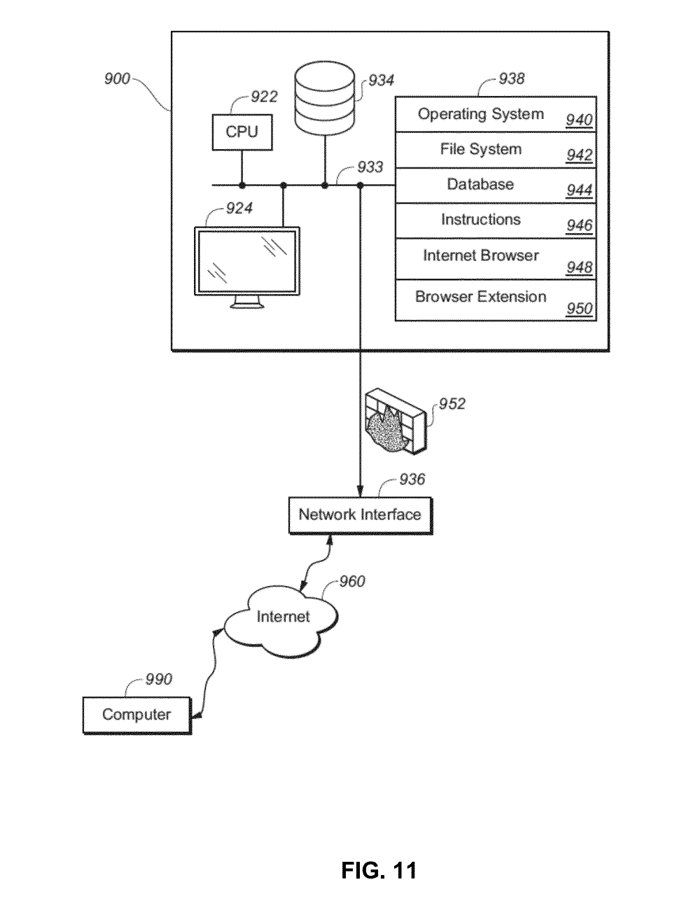

The context of a client implementation is shown in outline in FIG. 10. In this particular example, an internet browsing device such as a laptop 701, running a web-browser 705 such as FireFox with a custom browser extension 707 represents the client. The clickstream monitoring software resides in the extension 707; such an extension enables the recording, viewing, and sharing of clickstreams.

Packaged within the custom browser extension is a web socket library 709 such as socket.IO that enables communication through WebSockets (a standard protocol) with a socket server. The browser extension can be built using HTML5, CSS3 and JavaScript to offer a user interface that enables users to control what clickstream data is being recorded, and what clickstream data to share while providing various ways of viewing the data. This is facilitated by event listeners and data exchanges between the browser and the browser extension through the browser add-on architecture.

Synchronous data, including logging in is communicated between the web server and browser extension using REST and JSON while asynchronous data such as clickstream data retrieval and updates is communicated between the socket server and the browser extension's client socket library using WebSockets.

API communication between the server and client is implemented over the REST or WebSockets layers, depending on the need or synchronous or asynchronous data exchange. This implementation is within the capability and knowledge of one of skill in the art.

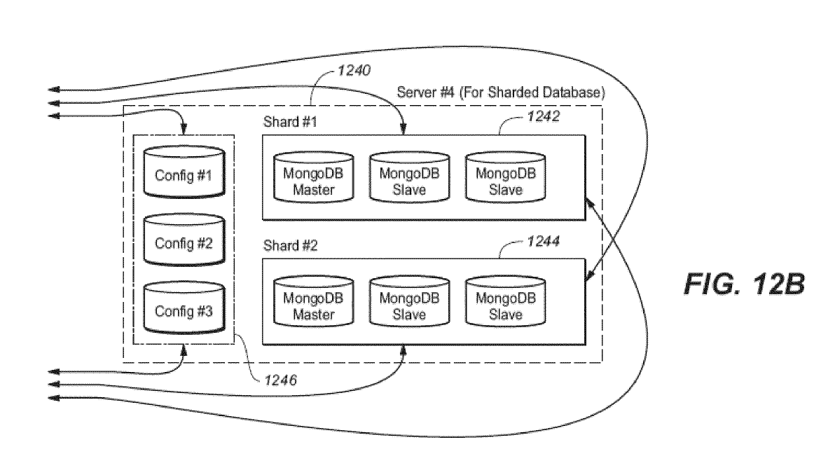

An exemplary server implementation is shown with respect to FIG. 12 (comprising FIGS. 12A, and 12B). It should be noted that simple implementations that rely on single threaded and multiple threaded instances of server use can be implemented with the capability of those of skill in the art. Such implementations address simple situations where a user connects to the server and wishes to, for example, share information about a newly-visited webpage to other members of a group. Web servers such as Tornado can handle multiple such requests from multiple users. Preferably the server utilizes a load-balancing layer.

A preferred embodiment of a database server for use with the clickstream technology herein is shown schematically in FIGS. 12A, 12B. Various functions are distributed over several different servers (or server clusters) 1210, 1220, 1230, and 1240. Client side communication begins with browser 1201 having a plugin 1203 (resident on a computer or a mobile device). Communications are channeled through a server-side load balancer 1205 before being distributed out amongst the various servers.

In this particular example, a NoSQL database such as MongoDB 1213, 1223, 1242, 1244 is employed so as to provide a flexible database structure. A flexible structure is important because it enables the storage of individual clickstreams while providing the ability to group them in various ways without having to restructure tables as a traditional SQL database would require. The logic for data queries and updates can be performed using the python programming language via the PyMongo interface. API's that clients can call are sourced from the PyMongo interface and exposed using either the REST of Socket.IO interfaces through the web server.

The technology also provides for Application Servers 1220 (includes the Portal, REST, static, session, and social server instances). An application server that provides the logic to render web pages on the Portal which enables users to view and manage their accounts and data in greater detail than through the browser extension can be constructed using Python and Django, with the Tornado web server serving up the pages to maximize flexibility and performance. The application server uses the same API calls as the browser extension in order to re-use as much of the database querying and update logic built using PyMongo as possible.

The technology also provides for a thumbnail Server 1230. In this embodiment, a separate server acts as the thumbnail server which loads URL's/URI's in recorded clickstreams and takes snapshots of the web pages so that they can be displayed by the clients. Various users 1232 (denoted as workers ##1-4) communicate web-page thumbnails to queue 1236, and thereafter to a thumbnail generator server 1238. The web page snapshots taken do not contain any private data as they are loaded by a 3^{rd} party server which has no personal information from any user. Thumbnail generation is managed by a queue to maximize efficiency. Static server 1234 serves up unchanging or relatively slowly changing material.

The technology also provides for a Socket Server 1210, as shown in FIG. 13. The Socket Server can be implemented using the Socket.IO library and is exposed through the Tornado web server, with the Tornado extension implemented to enable real-time persistent connections for WebSockets. Due to the single-threaded method in which the Tornado functions, implementing the Socket.IO library requires the implementation of a multi-threading and multi-processing architecture in order to prevent blocking.

A sharded database for maximum efficiency can be handled by server 1240. Three config servers (##1-3) will hold the meta data for the two sharded clusters. They will be deployed on three separate server instances to assure immediate data consistency and reliability.

The multi-threaded architecture involves a single web server process servicing many worker threads that process requests in parallel.

The multi-processing architecture also involves scaling the multi-threaded system to many processors (either machines or virtual systems) using load balancers.

### Computing Apparatus

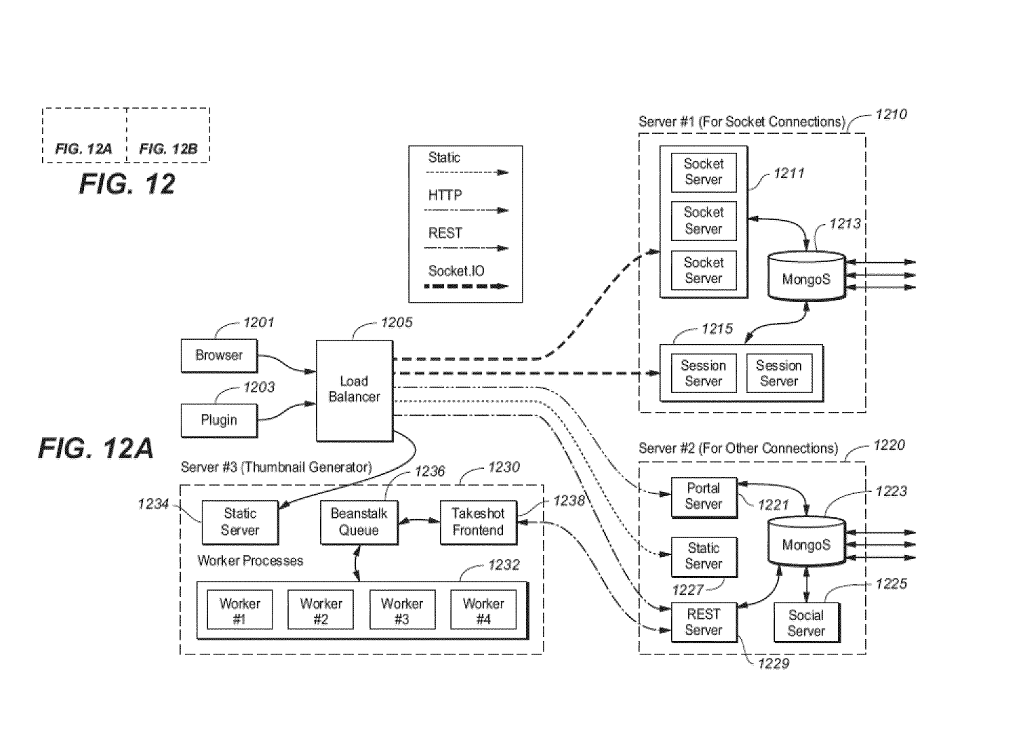

An exemplary general-purpose computing apparatus 900 suitable for practicing client-side methods described herein is depicted schematically in FIG. 11. Such a system could be used by any user who wishes to monitor and record their clickstreams, as described herein.

The computer system 900 comprises at least one data processing unit (CPU) 922, a memory 938, which will typically include both high speed random access memory as well as non-volatile memory (such as one or more magnetic disk drives), a user interface 924, one more disks 934, and at least one network connection 936 or other communication interface for communicating with other computers over a network, including the Internet 960, as well as other devices, such as via a high speed networking cable, or a wireless connection. There may optionally be a firewall 952 between the computer 900 and the Internet 960. At least the CPU 922, memory 938, user interface 924, disk 934 and network interface 936, communicate with one another via at least one communication bus 933.

Memory 938 stores procedures and data, typically including some or all of: an operating system 940 for providing basic system services; one or more application programs, such as a web-browser 948 and a browser extension 950, and a compiler (not shown in FIG. 11), a file system 942, one or more databases 944 that store data such as clickstreams or user or group data, and optionally a floating point coprocessor where necessary for carrying out mathematical operations. The methods of the present technology may also draw upon functions contained in one or more dynamically linked libraries, not shown in FIG. 11, but stored either in memory 938, or on disk 934.

The database and other routines shown in FIG. 11 as stored in memory 938 may instead, optionally, be stored on disk 934 where the amount of data in the database is too great to be efficiently stored in memory 938. The database may also instead, or in part, be stored on one or more remote computers that communicate with computer system 900 through network interface 936, according to methods as described herein.

Memory 938 is encoded with instructions 946 for at least: carrying out recording operations; manipulating URL's/URI's; and for accessing database records. In some embodiments, the database is not stored on the computer 900 that performs the display or monitoring but is stored on a different computer (not shown) and, e.g., transferred via network interface 936 to computer 900.

Various implementations of the technology herein can be contemplated, particularly as performed on one or more computing apparatuses of varying complexity, including, without limitation, workstations, PC's, laptops, notebooks, tablets, netbooks, and other mobile computing devices, including cell-phones, mobile phones, and personal digital assistants. The computing devices can have suitably configured processors, including, without limitation, graphics processors and math coprocessors, for running software that carries out the methods herein. In addition, certain computing functions are typically distributed across more than one computer so that, for example, one computer accepts input and instructions, and a second or additional computers receive the instructions via a network connection and carry out the processing at a remote location, and optionally communicate results or output back to the first computer.

Control of the computing apparatuses can be via a user interface 924, which may comprise a display, mouse, keyboard, and/or other items not shown in FIG. 9, such as a track-pad, track-ball, touch-screen, stylus, speech-recognition device, gesture-recognition technology, human fingerprint reader, or other input such as based on a user's eye-movement, or any subcombination or combination of inputs thereof.

The manner of operation of the technology, when reduced to an embodiment as one or more software modules, functions, or subroutines, can be in a batch-mode—as on a stored database of URL's/URI's, processed in batches.

The clickstreams can be displayed in tangible form, such as on one or more computer displays, such as a monitor, laptop display, or the screen of a tablet, notebook, netbook, or cellular phone. The clickstreams, can further be printed to paper form, stored as electronic files in a format for saving on a computer-readable medium or for transferring or sharing between computers, or projected onto a screen of an auditorium such as during a presentation.

Certain default settings can be built in to a computer-implementation, but the user can be given as much choice as he or she desires over the features that are used in recording and monitoring clickstreams.

### Example

### www.beenpod.com

An exemplary embodiment of the technology herein as implemented on a smartphone, such as one running Apple iOS, can be found at www.beenpod.com.

All references cited herein are incorporated by reference in their entireties.

The foregoing description is intended to illustrate various aspects of the instant technology. It is not intended that the examples presented herein limit the scope of the appended claims. The invention now being fully described, it will be apparent to one of ordinary skill in the art that many changes and modifications can be made thereto without departing from the spirit or scope of the appended claims.

1. (canceled)

2. (canceled)

3. (canceled)

4. A computing apparatus for synchronizing web-pages viewed by a group of users, the apparatus comprising:
an Internet connection;
a computer-readable memory, encoded with instructions;
a processor executing the instructions;
wherein the instructions provide for:
recording the clickstream of a session leader, wherein the clickstream comprises one or more URL's from the leader's Internet session; and
pushing the URL's from the clickstream of the session leader to a plurality of participants, through a bi-directional transport layer over the internet;
wherein the plurality of participants views the web-pages associated with the URL's at the same time as the session leader.

5. A method for synchronizing web-pages viewed by a group of users, the method comprising:
recording the clickstream of a session leader, wherein the clickstream comprises one or more URL's from the leader's Internet session; and
pushing the URL's from the clickstream of the session leader to a plurality of participants, through a bi-directional transport layer over the internet;
wherein the plurality of participants views the web-pages associated with the URL's at the same time as the session leader;
and wherein the method is performed on a computing apparatus.

6. A computer-readable medium encoded with instructions for implementing the method of claim 5.

7. (canceled)

8. (canceled)

9. (canceled)
